(19) United States
(12) Patent Application Publication
(10) Pub. No.: US 2018/0157630 A1
(43) Pub. Date: Jun. 7, 2018

(54) Video reading material / ubook

(71) Applicant: Melanie B. Schulz, Lockport, NY (US)

(72) Inventor: Melanie B. Schulz, Lockport, NY (US)

(21) Appl. No.: 15/530,093

(22) Filed: Dec. 1, 2016

(51) Int. Cl. G06F 17/24

(52) U.S. Cl. CPC G06F 17/24

(57) ABSTRACT

Reading material on video, or Ubooks, was created to give the reader a seamless reading experience by displaying on a device of their choice a series of segments containing letters, words, phrases, sentences and/or paragraphs on a background of the drafter's choice. One segment flows into the other until the reading material is completed. These sequential segments are set to be viewed seamlessly with or without audio accompaniment.

### CROSS-REFERENCE TO RELATED APPLICATIONS

This application claims the benefit of provisional patent application Ser. No. 62/388,795 filed 2016, Mar. 17 by the present inventor, which is incorporated by reference in its entirety.

### BACKGROUND

The present invention relates to reading material, and more specifically to the different formats in which they are consumed.

### BACKGROUND—PRIOR ART

The following is a tabulation of some prior art that presently appears relevant:

The Traditional Book: as in words placed on paper to be read and/or consumed by the reader. Such works use finite resources to create, take up valuable space, and disengage the reader each time a page is turned.

Electronic Book, or ebook: the first being created by Michael Hart, 1971, followed by many other relevant patents: U.S. Pat. No. 5,761,485 (June 1998, Munyan), U.S. Pat. No. 6,229,502 (May 2001, Schwab), U.S. Pat. No. 4,855,725 (September 2089, Fernandez), EP 0390611 (October 1990, Tsuchiya), WO1997020274 (June 1997, Munyan), WO 1987001481 (August 1987, Stein). Each solves the question of finite resources and space, but does not tackle the issue of the disengaged reader who had to step out of the story long enough to manually click/swipe a page turn.

Enhanced Books: Enhanced books, like ebooks, take into consideration finite resources and space and do offer enhancements such as music/video/hyperlinks, among others. Examples of these advancements are: U.S. Pat. No. 9,053,640 (June 2015, Hendricks, Asmussen), US 20110261030 (October 2011, Bullock), US 20130209981 (August 2013, Newell), US 20160059146 (March 2016, Javida, Savino, Tydingco, Zarich, Weiss), US 20090235162 (September 2009, Nuccio, Martinez, Tynan-Winters, Nebel), US 20120001923 (January 2012 Weinzimmer, Weinzimmer), and Adaptive Audio, released from Marvel Comics on Mar. 12, 2014 at SXSW. In some cases these enhancements are automatic, but the progression in the story is not. In each case, the reader must still manually advance the reading material with a click of a button or a swipe of a finger, thus taking the reader further out of the story the author has created. There are many patents/patent applications/articles pertaining to the enhancements of ebooks/books, but no one has addressed the need for a fully engaged reader—one who is not being constantly and consistently pulled out of the world the author has tried to create.

The closest the problem was to being addressed was by the authors of U.S. Pat. No. 7,853,900 B2 (Nguyen, Yawitz), when they stated: “When the user reads the book in electronic form, the user typically must wait for the computer monitor to render the book's pages as the user reads the book. A provider of electronic media items faces various challenges, as many users continue to prefer consuming media items in traditional form. The provider confronts the task of capturing the interest of such users, while providing a solution that is viable from a technical standpoint and a business-related standpoint. For instance, the provider faces the challenge of rendering the book's pages in an efficient manner that does not cause the user to lose interest in the media item.” Their solution as described in this patent: animating the curser.

Advantages:

The prior art listed all fail to give the reader the seamless reading experience this invention offers, and in the case of the traditional book, finite resources and space are also squandered. This invention delivers both: a reading experience on devices readily available, and immersion into reading material without the wait and distraction of a page turn.

### SUMMARY

In accordance with the embodiments, reading material on video/Ubook offers a seamless option for the reader to be immersed into the written word.

### DRAWINGS

FIG. 1: An Example of a background

FIG. 2: An example of a first segment

FIG. 3: An example of a second segment

FIG. 4: An example of a third segment

FIG. 5: An example of a completed background

FIG. 6: A new segment is begun to continue the story—does not need to be on the same background as was used prior.

FIG. 7: The working screen of Adobe Creative Cloud Premiere Pro CC

Due to the fluid nature of Reading Material on Video/Ubooks, drawings of the completed invention are seen as greatly limiting in it's description. Please see: https://www.youtube.com/watch?v=B6ubumbz8Gk for a completed example.

### DETAILED DESCRIPTION—FIRST EMBODIMENT

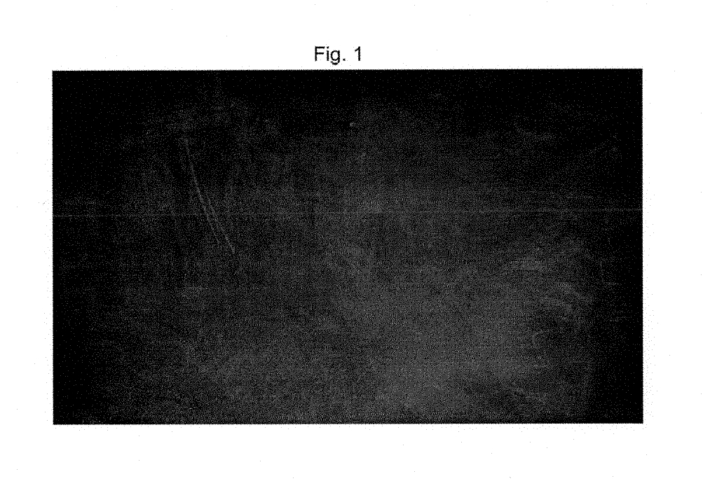

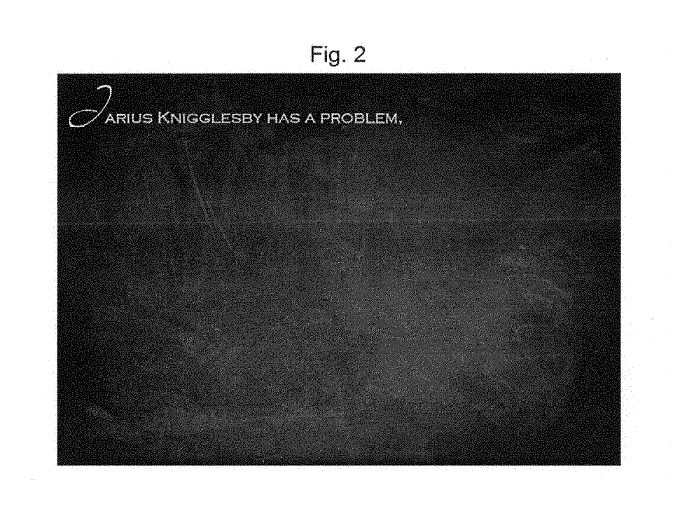

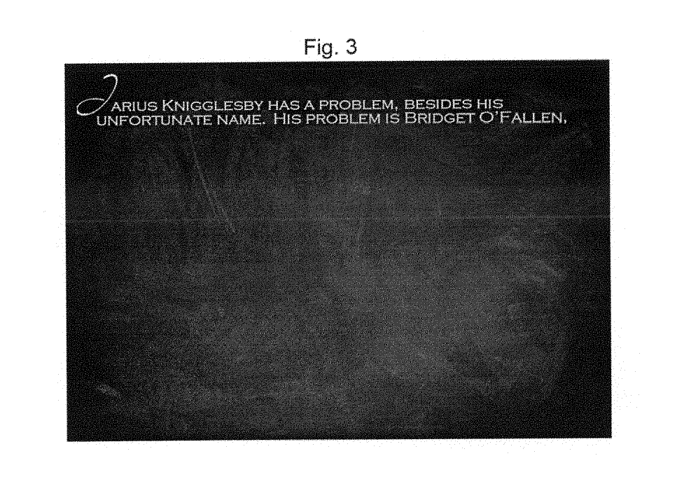

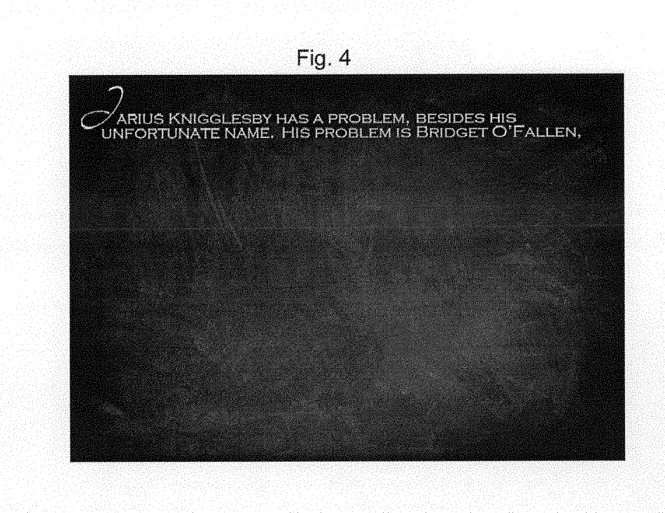

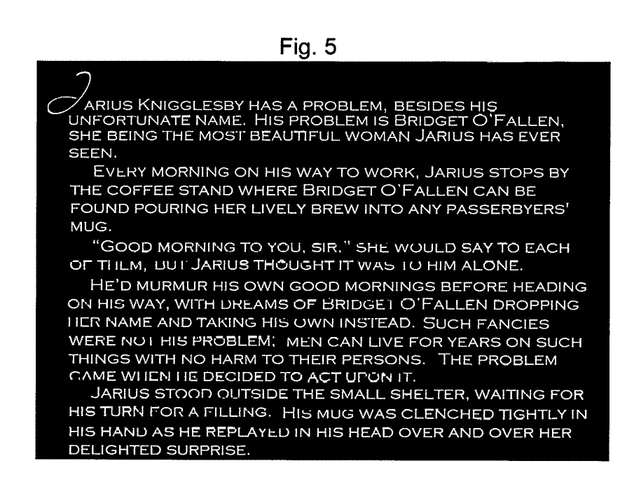

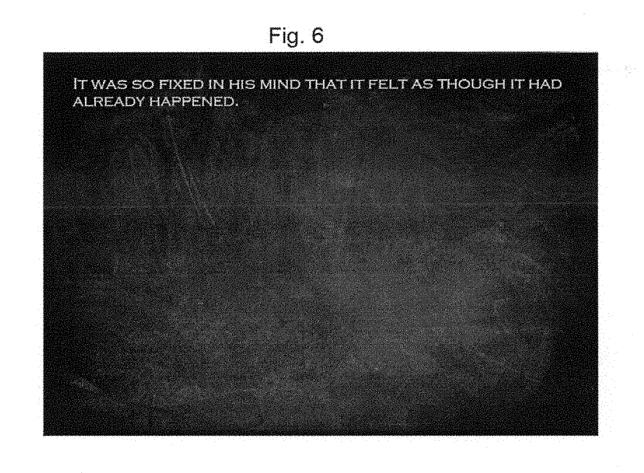

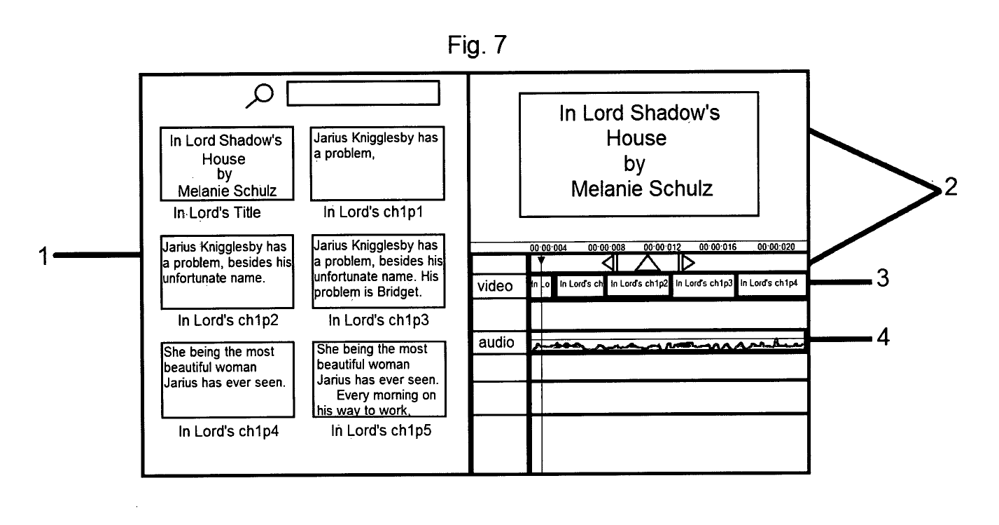

Reading material on video, or Ubooks, are created by drafting a series of segments, placing them in order, setting them at reading speed, and exporting the finished product on video feed to be enjoyed by the consumer on a device of their choosing. The steps to completing this are such:
1. A segment is drafted by first choosing a background (FIG. 1). This background can be anything from a blank screen to an artist's masterpiece. The choice is up to the drafter. If an artist's masterpiece, a picture is taken of the artwork and uploaded onto the software to be further drafted upon. Other backgrounds may be used as well, as many as the imagination may create and are not meant to be limited by the description of this invention. Simply put, if it can be uploaded onto a computer, it may be used.
2. Upon this background, using commonly available computer software, at present I am using Microsoft Paint, letters, words, sentences, and/or paragraphs are placed (FIG. 2). Presently I am copying and pasting from existing Microsoft Word documents, but letters, words, sentences, and/or paragraphs may be typed directly onto the background as well.
3. The segment is saved. I currently save them on a flash drive.
4. If needed, a second segment is drafted as a continuation of the first segment, including and adding to all the letters, words, sentences, and/or paragraphs of the first segment (FIG. 3).
5. The second segment is saved, again, on a flash drive.
6. This process is continued, creating as many segments as needed to complete the page (FIGS. 4 and 5).
7. If needed, a new page is begun and the process is repeated until the reading material is completed (FIG. 6). It is noted here that the same background need not be used on the new page. In the example of a picture book, each page has a unique background picture.
8. The segments are then transferred to commonly available software via the flash drive. Currently I am using Adobe Creative Cloud Premier Pro CC to accomplish the creation of this video feed. When the flash drive is accessed via the software, the contents are displayed on the left side screen (FIG. 7-1). I then place my mouse over the segment I want to begin with and drag it to the main working screen on the right (FIG. 7-2).
9. These segments are shortened or lengthened for time based on reading pace, by clicking each individual segment in the working screen and lengthening or shortening them by scrolling them longer or shorter with the mouse. See examples of various lengths of segments in FIG. 7-3.
10. Audio accompaniment may be added by adding it to the working screen (FIG. 7-4). This is accomplished by transferring selected audio feed to commonly available software, as mentioned before, I utilize flash drives to facilitate this. The placing of audio feed is much the same as the visual segments, it just needs to be placed in the Audio Clip portion of the software, which in Adobe Creative Cloud Premiere Pro CC, is below the visual feed on the main working screen (FIG. 7-4). This audio feed may be adjusted for time in the same way the visual segments are adjusted; with the clicking and dragging of the mouse to shorten or lengthen the feed. This allows the audio segment(s) to be played simultaneously with the visual feed.

Once all segments are added, and lengthened or shortened based on reading speed, and optional audio has been added, this reading material on video/Ubook is then saved and exported to be viewed by the consumer (see: https://www.youtube.com/watch?v=B6ubumbz8Gk). Currently I am utilizing Youtube to facilitate this.

### Operations—First Embodiment

Reading material on video, or Ubooks, have been created to engage the reader seamlessly throughout the reading experience. Operating video reading material is as simple as reading itself. The operator, on a device of their choice, presses play and reads the text as it is displayed upon the screen until said text is completed. Text may be paused or stopped, as is typically offered with video feed. Currently I am using Youtube to facilitate this.

### CONCLUSIONS, RAMIFICATIONS, AND SCOPE

The reader will see that just as the animated movie was to the still piece of artwork, so this invention is to the written word; bringing it to life. Imagine the distraction of continually having to press play while watching a film—the same is true for the turning of a page or swiping of a finger while attempting to read a book. It pulls you out of the story.

What is claimed is:

1. Reading Material on Video/Ubooks, comprising playing on a device a series of reading material segments set sequentially and played continuously until said segments have been completed, whereby a seamless reading experience may be had.

2. A method of drafting Reading Material on Video/Ubooks whereby
a. a segment is drafted by placing a letter, a word, a sentence, and/or a paragraph on a selected background
b. said segment is saved
c. once saved, additional said letters, words, sentences, and/or paragraphs are added to the previous, drafting a second said segment, if needed
d. said second segment is saved
e. said segment drafting continues until said background is determined to be complete at which time, if additional said segments are needed, said selected background, or, if needed, a different selected background is accessed, and the process is continued until the reading material is completed
f. said segments are placed in sequential order and exported, whereby they are set to play on a device at reading pace whereby the reader may enjoy a seamless reading experience.
